(19) United States
(12) Patent Application Publication
(10) Pub. No.: US 2017/0059027 A1
(43) Pub. Date: Mar. 2, 2017

(54) CAM FOLLOWER DESIGN FOR A PICKUP REEL

(71) Applicant: HCC, Inc., Mendota, IL (US)

(72) Inventor: Edward Patrick Jasper, Mendota, IL (US)

(21) Appl. No.: 15/251,249

(22) Filed: Aug. 30, 2016

Related U.S. Application Data
(60) Provisional application No. 62/212,110, filed on Aug. 31, 2015.

(51) Int. Cl. F16H 53/06

(52) U.S. Cl. CPC F16H 53/06; A01D 89/002

(57) ABSTRACT

A cam follower design wherein a cam track is provided proximate one or both ends of a harvester pick-up reel. Cam followers travel along the cam track as the pick-up reel rotates to move crop into the harvester. At least one roller of each cam follower engages and rolls along an interior edge surface of the cam track, and at least one other roller of each cam follower engages and rolls along an exterior edge surface of the cam track. The rollers are preferably engaged with a carrier member which is linked to a corresponding bat tube. Each cam follower preferably also includes at least one over center stop which is configured to maintain the intended radial position of the bat tube.

### RELATED APPLICATION (PRIORITY CLAIM)

This application claims the benefit of U.S. Provisional Application Ser. No. 62/212,110, filed Aug. 31, 2015, which is hereby incorporated herein by reference in its entirety.

### BACKGROUND

The present invention generally relates to cam follower designs for harvester pick-up reels, and more specifically relates to a cam follower design wherein a cam track is disposed between flanged roller bearing followers which ride on the edge surfaces of the cam track.

A conventional harvester includes a pick-up reel that includes a reel tube, bat tubes parallel to the reel tube, and tines on the bat tubes for moving crop into the harvester. This is standard in the industry. Many pick-up reels in the industry also include a cam at one or both ends of the pick-up reel, and cam followers which are linked to the bat tubes. The cam followers move along the cam as the pick-up reel rotates. As such, the cam effectively controls and dictates the radial positions of the bat tubes as the pick-up reel rotates and moves crop into the harvester.

U.S. Pat. No. 7,665,287 discloses a cam which provides a cam track wherein cam followers (which are linked to bat tubes) travel between inner and outer cam rings. More specifically, between the inner and outer cam rings is a space which effectively defines a channel, and it is within that channel that the cam followers travel. In practice, the cam track (i.e., the channel between the cam rings) in this configuration is often nearly two inches wide in order to accept large enough cam followers and guarantee that the cam followers stay engaged in the channel. This wide, stationary structure at the end of the pick-up reel can disrupt crop feeding and cause plugging of crop between this structure and a header end sheet.

### SUMMARY

An object of an embodiment of the present invention is to provide a cam follower design for a pick-up reel of a harvester which prevents plugging between the cam and the header end sheet.

Briefly, an embodiment of the present invention provides a cam follower design wherein a cam track is provided proximate one or both ends of a harvester pick-up reel. Cam followers travel along the cam track as the pick-up reel rotates to move crop into the harvester. At least one roller of each cam follower engages and rolls along an interior (i.e., relative to a longitudinal axis of a reel tube of the pick-up reel) edge surface of the cam track, and at least one other roller of each cam follower engages and rolls along an exterior edge surface of the cam track. The rollers of each cam follower are preferably engaged with a carrier member which is linked to a corresponding bat tube of the pick-up reel. Each cam follower preferably also includes at least one over center stop which is configured to maintain the intended radial position of the bat tube to which the cam follower is linked.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 shows a harvester and pick-up reel, wherein a cam follow design in accordance with an embodiment of the present invention is being used;

FIG. 2 is a perspective view of an end of the pick-up reel of FIG. 1, showing a cam follower engaged with a cam track;

FIG. 3 is a close up view of a section of the cam track shown in FIG. 2, showing the cam follower engaged with the cam track;

FIG. 4 is an end view of that which is shown in FIG. 3;

FIGS. 5 and 6 are very similar to FIGS. 3 and 4, but show a more preferred design which has integral over center stops; and

FIG. 7 is much like FIG. 5, but illustrates an embodiment where a roller guard is included to cover the rollers.

### DESCRIPTION OF ILLUSTRATED EMBODIMENTS

While this invention may be susceptible to embodiment in different forms, there are shown in the drawings and will be described herein in detail, specific embodiments with the understanding that the present disclosure is to be considered an exemplification of the principles of the invention, and is not intended to limit the invention to that as illustrated.

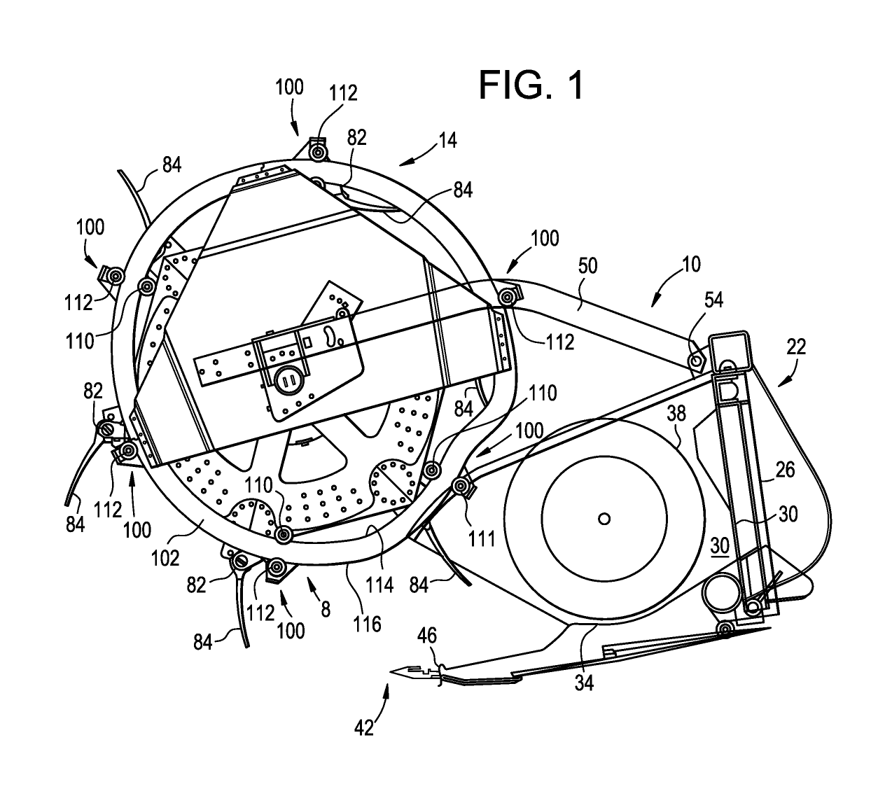

As shown in FIG. 1, an embodiment of the present invention is a cam follower design 8 which is configured for use with a pick-up reel 14 of a harvester 10. As shown in FIG. 1, the harvester 10 may be conventional and include a harvesting platform 22, a platform frame 26 supported for movement over ground, and side and rear walls 30. A floor 34 extends between the opposite side walls 30. A transverse crop converging auger 38 is shown and is rotatably supported above the floor 34 and forward of the rear wall 30. Transverse crop transfer could also be accomplished with a draper platform wherein a belt on the floor 34 moves the crop. A transverse cutter bar 42 is mounted along the forward edge of the floor 34, and an upright crop dam 46 is supported between the cutter bar 42 and the floor 34.

The pickup reel 14 generally spans the width of the platform 22, forward of the auger 38 and above the cutter bar 42. The pickup reel 14 is connected to the platform 22 by a pair of reel support arms 50 (one shown) which support the pickup reel 14 on the frame 26. In the illustrated construction, the support arms 50 are pivotally connected to the frame 26 at pivot points 54. The support arms 50 are generally above the side walls 30 of the platform 22. Preferably, the support arms 50 are selectively vertically adjustable by a pair of cylinders (not shown) connected between the support arms 50 and the side walls 30.

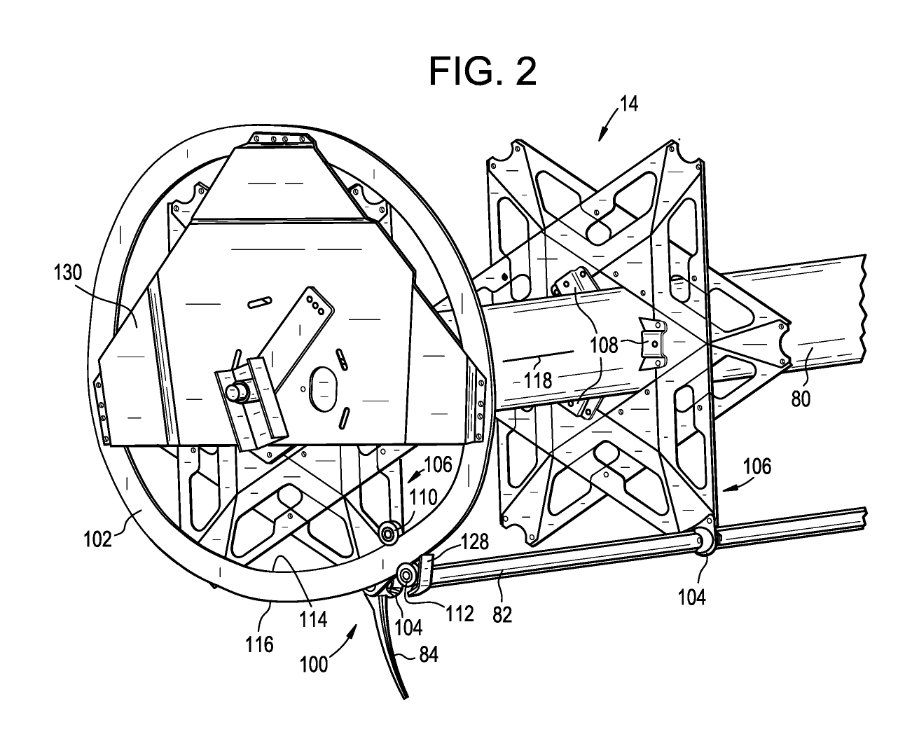

Other than including a cam follower design which is in accordance with an embodiment of the present invention, the pick up reel 14 may be conventional and include a reel tube 80 (see FIG. 2), and bat tubes 82 each of which is parallel to the reel tube 80. Preferably, there are tines 84 engaged with the bat tubes 82, and the tines 84 work as fingers to grab the crop. All this is conventional with regard to the structure and function of a pick-up reel.

Each bat tube 82 of the pick-up reel is preferably linked to a cam follower 100 which follows along a cam track or cam rail 102 proximate the end of the pick-up reel 14. There may be a cam track and corresponding cam followers at each end of the pick-up reel. In other words, there may be cam follower at each end of each bat tube. Regardless, one of the cam followers 100 will now be described in detail.

The above description regarding FIG. 1 was merely provided to explain one possible environment in which the present invention may exist, and should not be considered to be limiting in any way, as the present invention can be employed with pick-up reels and harvesters which are different than that which is illustrated in FIG. 1.

FIG. 2 is a perspective view of a cam follower design which is in accordance with an embodiment of the present invention, showing the cam follower design employed at the end of a harvester pick-up reel. As shown, the pick up reel 14 may include a reel tube 80, and a plurality of bat tubes 82 which are parallel to the reel tube 80 (only one bat tube 82 is shown in FIG. 2, for simplicity). The bat tubes 82 may be held in place by bearings 104 (only one shown in FIG. 2) which are attached to a frame 106. The frame 106 is preferably attached, such as via brackets 108, to the reel tube 80. Specifically, the brackets 108 may be welded to or otherwise attached to the reel tube 80. A frame 106 may be provided every so often along the reel tube 80, in order to give the bat tubes 82 stability with regard to bending, due to their length. As such, the bat tubes 82 may be attached to a plurality of frames 106, wherein each frame 106 is attached to the reel tube 80. All this is just one possible configuration of a pick-up reel with which a cam follower design in accordance with an embodiment of the present invention can be used.

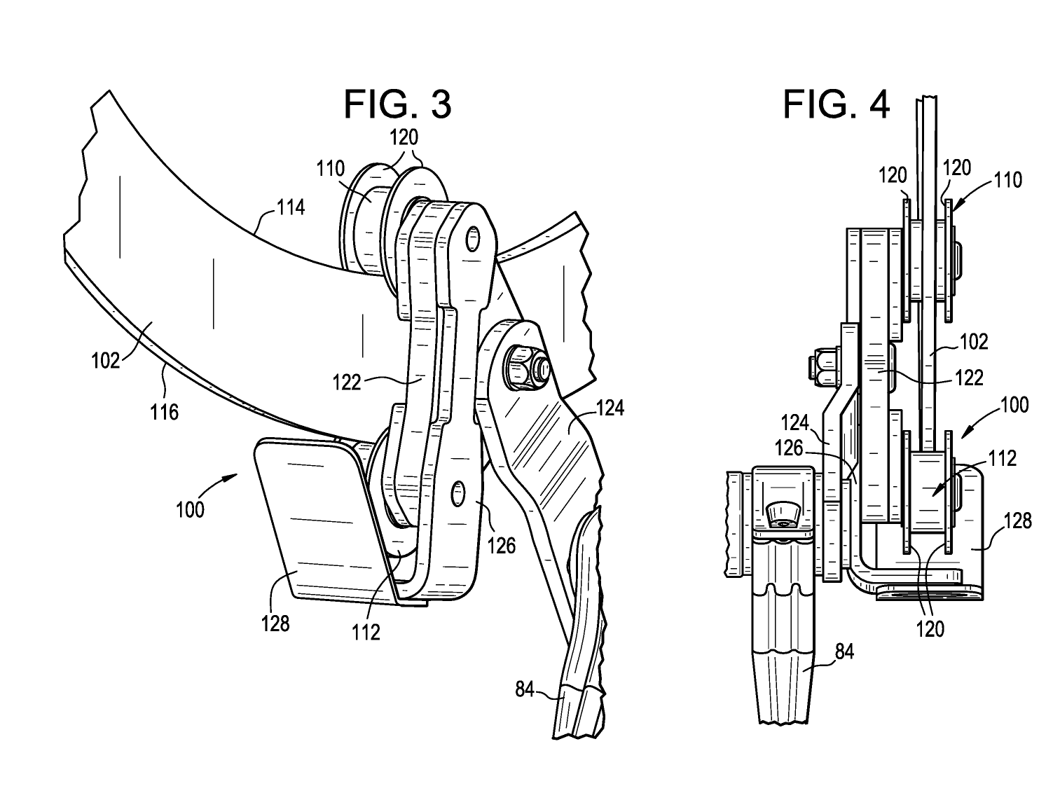

As shown in FIG. 2, the cam follower design provides that a cam rail or cam track 102 is mounted at the end (or both ends) of a pick-up reel. Cam followers 100 (one for each bat tube 80) are mounted on the cam track 102. FIG. 3 is a close up view of a section of the cam track 102, showing a cam follower 100 engaged with the cam track 102. As shown in FIGS. 2 and 3, each cam follower 100 includes a plurality of rollers 110, 112. While two rollers 110, 112 are shown in FIGS. 2 and 3, each cam follower 100 may have more than two rollers. Regardless, at least one of the rollers 110 of the cam follower 100 is configured to engage and ride along an inside edge 114 (i.e., relative to a longitudinal axis 118 (see FIG. 2) of the reel tube 80 of the pick-up reel) of the cam track 102, and at least one of the other rollers 112 of the cam follower 100 is configured to engage and ride along an outside edge 116 of the cam track 102. To facilitate this, preferably each roller 110, 112 is provided with flanges 120, and the cam track 102 is disposed between the flanges 120 (see both FIGS. 3 and 4). Given this configuration, each roller 110, 112 may be considered to be a flanged roller bearing follower. Regardless, given that there is at least one roller 110 which engages and rides along the inside edge 114 of the cam track 102, and there is at least one other roller 112 which engages and rides along the outside edge 116 of the cam track 102, it can be said that the cam track 102 is disposed between the rollers 110 and 112, and the cam track 102 defines the path along which the rollers 110, 122 roll.

Preferably, the rollers 110, 112 of the cam follower 100 are engaged with a carrier member or roller bearing carrier 122, and the roller bearing carrier 122 is linked (i.e., via one or more crank arms 124) to one of the bat tubes 82 of the pick-up reel. In addition to being ultimately linked to the bat tube 82, the roller bearing carrier 122 may also be connected to, or otherwise engaged with, an over center stop 126. The over center stop 126 functions to prevent the bat tubes 82 from fully rotating causing the tines 84 on the bat tubes 82 to flip.

As shown in FIGS. 2-4, the over center stop 126 is preferably integral with, or at least connected to, a roller guard 128 which is configured to effectively shroud and protect at least one of the rollers (such as roller 112). Preferably, the roller guard 128 functions to prevent crop entanglement and/or damage of the roller caused by an obstruction. The roller guard 128 is not detrimental, and may be omitted from the design.

In operation, as the pick-up reel rotates, the cam followers 100 travel and along the cam track 102. Specifically, the rollers 110, 112 of the cam follower 100 roll along the cam track 102. As such, the cam track 102 effectively controls and dictates the radial positions of the bat tubes 82 as the pick-up reel 14 rotates and moves crop into the harvester 10.

The cam track 102 itself can be provided as having one of many different overall shapes in terms of defining the path of travel of the cam followers 100. Additionally, the cam track 102 can be provided as having one of many different shapes in terms of cross-section. For example, the cam track 102 can be provided as having a simple, rectangular cross-section. Alternatively, the cam track 102 may have a more complex cross-section, such as an “I” shape.

The cam track 102 can be provided as being a single piece, or may be provided in sections which are connected together, or at least generally aligned end to end. Regardless, as shown in FIG. 2, an end sheet or end plate 130 may be attached to the cam track 102 (or the sections thereof) at the end of the pick-up reel. A similar cam track, etc. may be provided at the other end of the pick-up reel, such that each bat tube has two cam followers connected thereto—i.e., one at each end of the bat tube, for engaging a corresponding cam track.

The cam track 102 can be provided as being quite thin. As such, the cam track 102 is less disruptive to crop, and the movement of the rollers 110, 112 of the cam followers 100 along the cam track 102 works to prevent plugging.

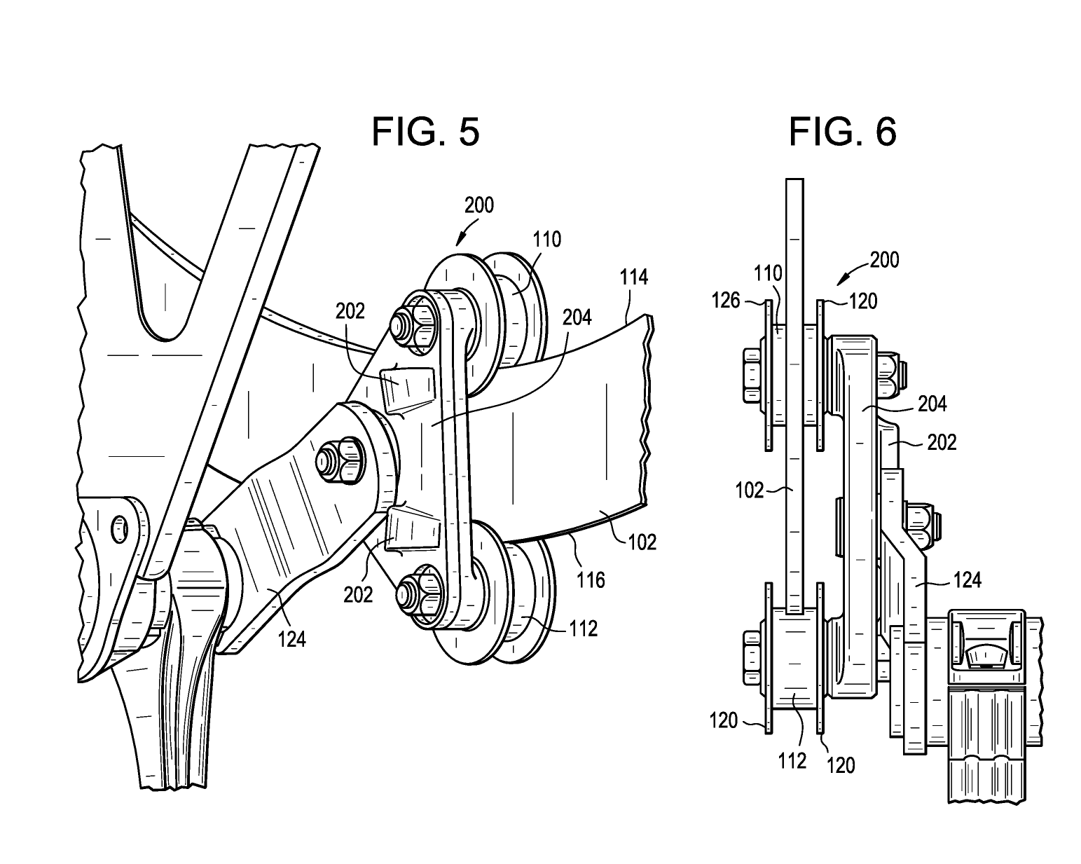

FIGS. 5 and 6 are very similar to FIGS. 3 and 4, but show a more preferred cam follower design 200 which, instead of having an over center stop 126 which is connected to the roller bearing carrier 122 (see FIG. 3), has at least one over center stop 202 which is integral with the roller bearing carrier 204. In the design shown in FIGS. 5 and 6, preferably the roller bearing carrier 204 of each cam follower 200 is a casting having two over center stops 202 in the form of, for example, raised or ramped surfaces. As shown, preferably the roller guard 128 shown in FIG. 3 is omitted from the preferred cam follower design 200 shown in FIGS. 5 and 6. Other than that, preferably all the parts and operation are identical to what has been described previously with regard to FIGS. 1-4. Therefore, like part numbers have been used to identify like parts in FIGS. 5 and 6.

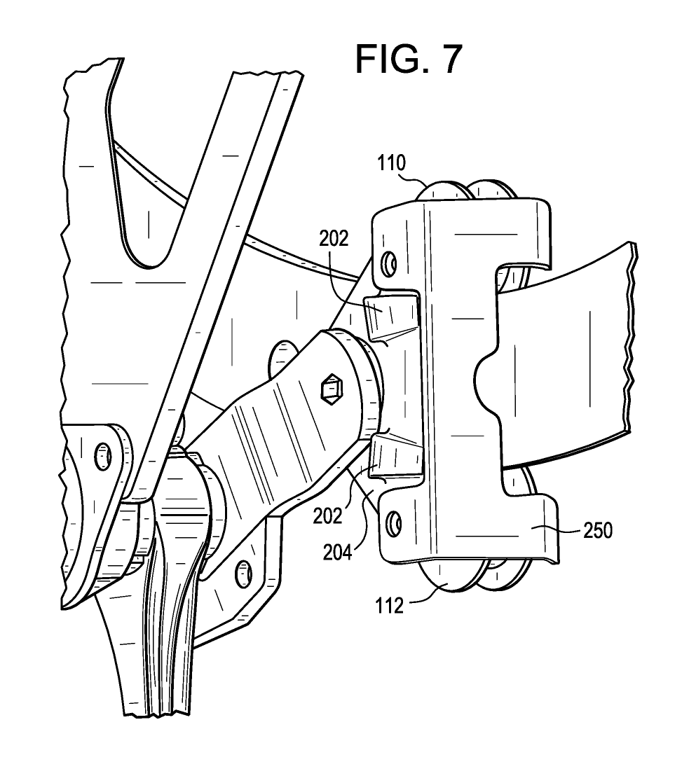

FIG. 7 shows still another embodiment, which is very much like the embodiment shown in FIGS. 5 and 6, except a roller guard 250 is included, connected to the roller bearing carrier 204, to cover both rollers 110 and 112. As shown in FIG. 7, the roller bearing carrier 204 preferably has over center stops 202 thereon much like the embodiment shown in FIGS. 5 and 6 and described previously.

While specific embodiments of the present invention have been shown and described, it is envisioned that those skilled in the art may devise various modifications without departing from the spirit and scope of the present invention. For example, each cam follower may include multiple rollers on each side of the cam track. Still other variations are entirely possible while staying within the scope of the present invention.

What is claimed is:

1. A cam follower design for a pick-up reel of a harvester, said cam follower design comprising: a cam track having an interior edge and an exterior edge; a plurality of cam followers configured to travel along both the interior and exterior edges of the cam track as the pick-up reel rotates to move crop into the harvester.

2. The cam follower design as recited in claim 1, wherein each cam follower comprises a plurality of rollers.

3. The cam follower design as recited in claim 2, further comprising a roller guard which covers at least one of the rollers.

4. The cam follower design as recited in claim 2, wherein each of said plurality of rollers contacts and rides along the cam track.

5. The cam follower design as recited in claim 1, wherein each cam follower comprises a first roller which rolls along the interior edge of the cam track, and a second roller which rolls along the exterior edge of the cam track.

6. The cam follower design as recited in claim 1, wherein each cam follower comprises a roller bearing carrier and a plurality of rollers which are engaged with the roller bearing carrier.

7. The cam follower design as recited in claim 6, wherein the roller bearing carrier of each cam follower is linked to a corresponding bat tube of the pick-up reel.

8. The cam follower design as recited in claim 2, wherein each cam follower comprises an over center stop which is configured to maintain an intended radial position of the bat tube to which the cam follower is linked.

9. The cam follower design as recited in claim 8, wherein each cam follower comprises a roller bearing carrier to which the rollers are connected, wherein the over center stop is integral with the roller bearing carrier.

10. The cam follower design as recited in claim 9, wherein the over center stop comprises at least one raised surface on the roller bearing carrier.

11. The cam follower design as recited in claim 5, wherein each cam follower comprises an over center stop which is configured to maintain an intended radial position of the bat tube to which the cam follower is linked.

12. The cam follower design as recited in claim 10, wherein each cam follower comprises a roller bearing carrier to which the rollers are connected, wherein the over center stop is integral with the roller bearing carrier.

13. The cam follower design as recited in claim 12, wherein the over center stop comprises at least one raised surface on the roller bearing carrier.

14. The cam follower design as recited in claim 2, wherein each roller is provided with flanges, and the cam track is disposed between the flanges.

15. The cam follower design as recited in claim 14, wherein the cam track defines a path along which the rollers roll.

16. The cam follower design as recited in claim 1, wherein each cam follower comprises a plurality of rollers, wherein a first roller which rolls along the interior edge of the cam track, and wherein a second roller rolls along the exterior edge of the cam track, wherein each cam follower comprises a roller bearing carrier and the plurality of rollers are engaged with the roller bearing carrier, wherein the roller bearing carrier of each cam follower is linked to a corresponding bat tube of the pick-up reel, wherein each cam follower comprises an over center stop which is configured to maintain an intended radial position of the bat tube to which the cam follower is linked.

17. The cam follower design as recited in claim 16, wherein the over center stop is integral with the roller bearing carrier.

18. The cam follower design as recited in claim 17, wherein the over center stop comprises at least one raised surface on the roller bearing carrier.

19. The cam follower design as recited in claim 16, wherein each roller is provided with flanges, and the cam track is disposed between the flanges.

20. The cam follower design as recited in claim 16, further comprising a roller guard which covers at least one of the rollers.
